(19) United States
(12) Patent Application Publication
(10) Pub. No.: US 2002/0003805 A1
(43) Pub. Date: Jan. 10, 2002

(54) Underground broadcasting system

(75) Inventor: Chiharu Kamise, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: FUJI TELEVISION NETWORK, INC., Tokyo (JP)

(21) Appl. No.: 09/814,706

(22) Filed: Mar. 23, 2001

(30) Foreign Application Priority Data
Jul. 5, 2000 (JP) 2000-203718

(51) Int. Cl. H04Q 11/02

(52) U.S. Cl. 370/430; 370/480

(57) ABSTRACT

An improved underground broadcasting system is composed of an information delivering system 14 for delivering broadcast information to a transmitter apparatus; a plurality of transmitter apparatuses 13a and 13b for transmitting the broadcast information as delivered from the information delivering system on carriers as modulated by an OFDM modulation at the same base band frequency; and a receiver apparatus for receiving the broadcast information as transmitted on the carriers as modulated by the OFDM modulation, demodulating the broadcast information in order to obtain and output the broadcast information as reproduced. It is therefore possible to receive data of a program with a better quality even in an underground structure.

### CROSS REFERENCE TO RELATED APPLICATIONS

This application claims benefit of priority under 35 USC 119 based on Japanese patent applications No. 2000-203718, filed on Jul. 5, 2000, the entire contents of which are incorporated by reference herein.

### BACKGROUND OF THE INVENTION

1. Field of the Invention

The instant invention relates to an improved underground broadcasting system for broadcasting television programs of moving pictures, data broadcast programs and so forth in an underground structure such as station yards in a network of underground railways, an underground shopping area, a tunnel and so forth. In particular, the present invention is related to a technique for making it possible to receive the data of a program with a better quality by broadcasting the data of the program on the basis of OFDM (Orthogonal Frequency Division Multiplexing) which is one of multi-carrier digital modulation techniques.

2. Description of the Related Art

With the high speed advent of the broadcasting technique in the recent years, a general discussion of preparation of broadcasting networks has been given not only in the open space where radio waves can freely propagate but also in an underground structure, which is a closed space, such as station yards of a network in underground railways, an underground shopping area, a tunnel and so forth.

However, since the information as broadcasted has been modulated on the basis of an analog modulation in accordance with current broadcasting systems, it is impossible to receive images as contained in the information with a better quality, when the conventional broadcasting system is simply applied, e.g., to a network of underground railways, because of diffused reflections of radio waves due to the motion of the subway train itself, which is receiving the radio waves, or on other subway trains. For this reason, to date, it has not been realized yet to implement such a system for broadcasting television programs of moving pictures, data broadcast programs and so forth in an underground structure.

While several techniques have been introduced in order to solve the shortcomings, e.g., by recording information to be broadcasted on a storage medium such as a tape which is then reproduced to throw pictures onto a display in an underground structure, it is difficult by such a technique to provide the users with latest information.

Taking into account this context, it has been earnestly desired to provide a technique capable of implementing a system in which information desired by an audience can be broadcasted with a better quality on a real time basis in an underground structure.

The present invention has been made in the circumstances as described above. It is an object of the present invention to provide an underground broadcasting system for making it possible to receive the data of a television program of moving pictures, a data broadcast program and so forth in an underground structure.

### SUMMARY OF THE INVENTION

In order to solve the problem as described above, the inventors of the present invention have culminated the technical idea that it becomes possible to receive the data of a program without degradation and interference in propagation of radio waves even in an underground structure and, as a result of vigorous efforts, can successfully provide the technical concept with the following features.

In accordance with an aspect of the present invention, an underground broadcasting system is composed of an information delivering system for delivering broadcast information to a transmitter apparatus; a plurality of transmitter apparatuses for modulating the broadcast information as delivered from said information delivering system on carriers as modulated in accordance with an OFDM modulation at the same base band frequency and transmitting the broadcast information on said carriers; and a receiver apparatus for receiving the broadcast information as transmitted on said carriers as modulated by the OFDM modulation, demodulating said broadcast information in order to obtain and output the broadcast information as reproduced.

In accordance with this underground broadcasting system, since OFDM at the same base band frequency is employed as the modulation technique of modulating the broadcast information to be delivered, it is possible to implement an underground broadcasting system for receiving the broadcast information without degradation and interference in propagation of radio waves even in an underground structure.

In this case, it is desired to provide a transmitter/receiver antenna capable of transmitting/receiving broadcast information on OFDM carriers in an underground structure in order to make it possible to implement an underground broadcasting system with a fewer number of transmitter apparatuses.

Also, it is possible to use a mobile terminal, a computer system and so forth as the receiver apparatus so that the audience can enjoy broadcasting services with a better quality everywhere in the underground structure.

The underground structures in which the underground broadcasting system can be installed include station yards of a network in underground railways, an underground shopping area, a tunnel and so forth.

### BRIEF DESCRIPTION OF THE DRAWINGS

FIG.1 is a schematic diagram showing an information broadcasting system in accordance with an embodiment of the present invention.

FIG.2 is a schematic diagram for explaining signal processing by the information broadcasting system in accordance with the embodiment of the present invention.

FIG.3 is a block diagram showing an information transmitter apparatus and a receiver apparatus in accordance with the embodiment of the present invention.

FIG.4 is a schematic diagram showing a receiver apparatus in accordance with the embodiment of the present invention.

### DESCRIPTION OF THE PREFERRED EMBODIMENT

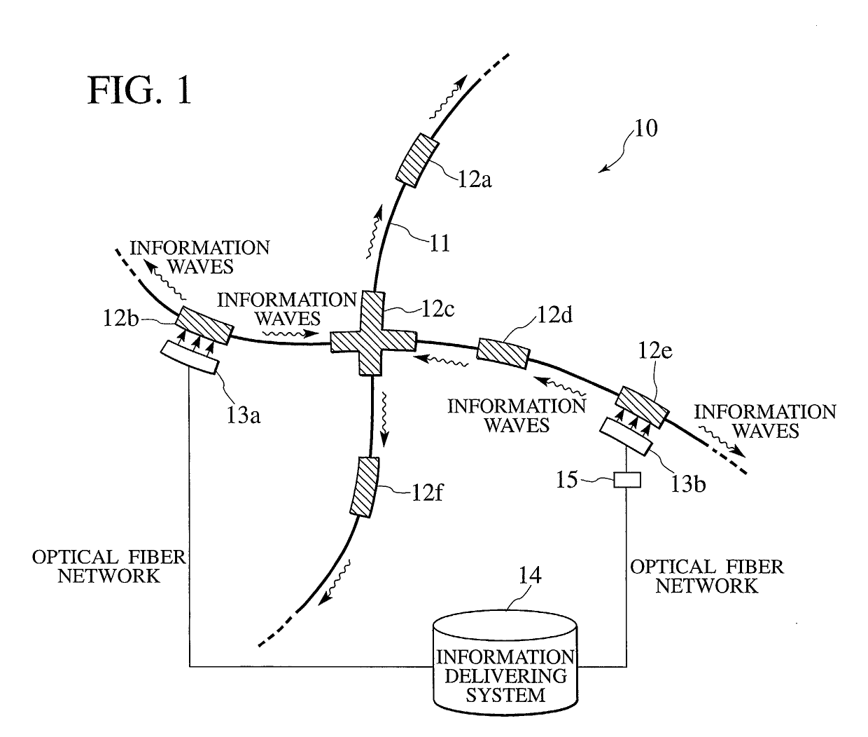

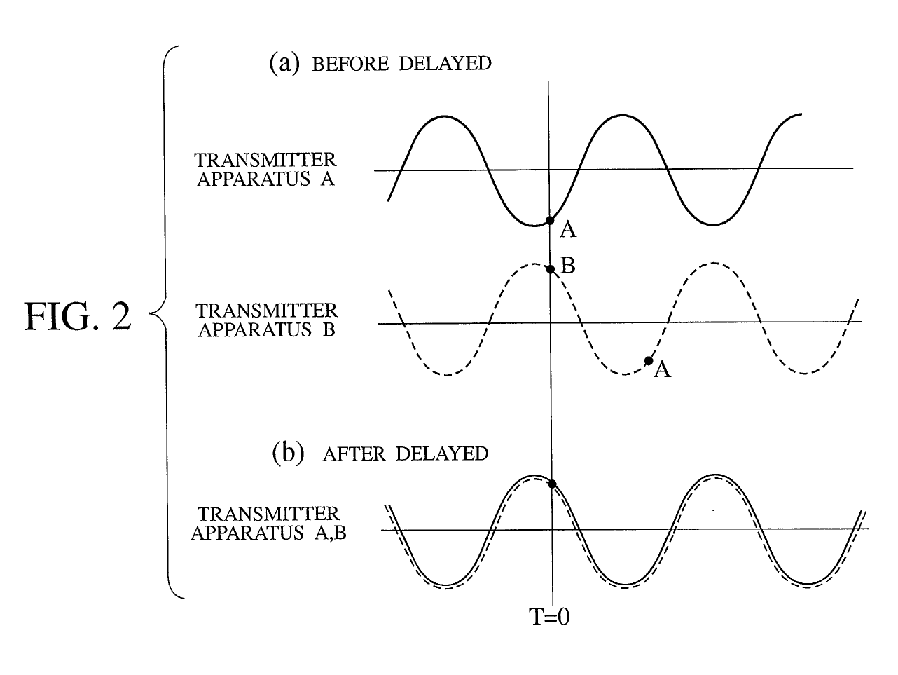

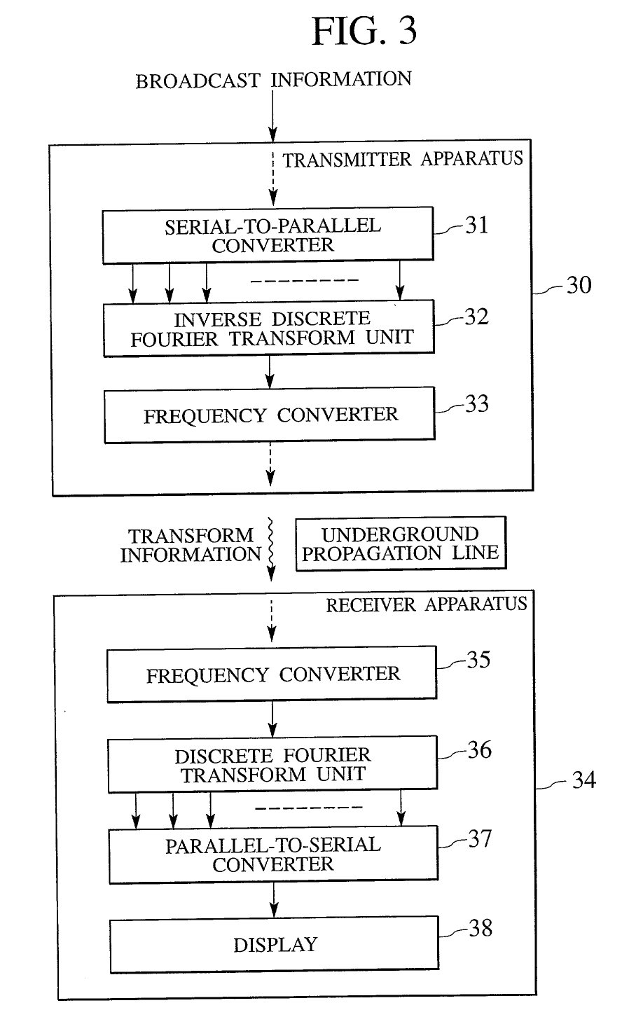

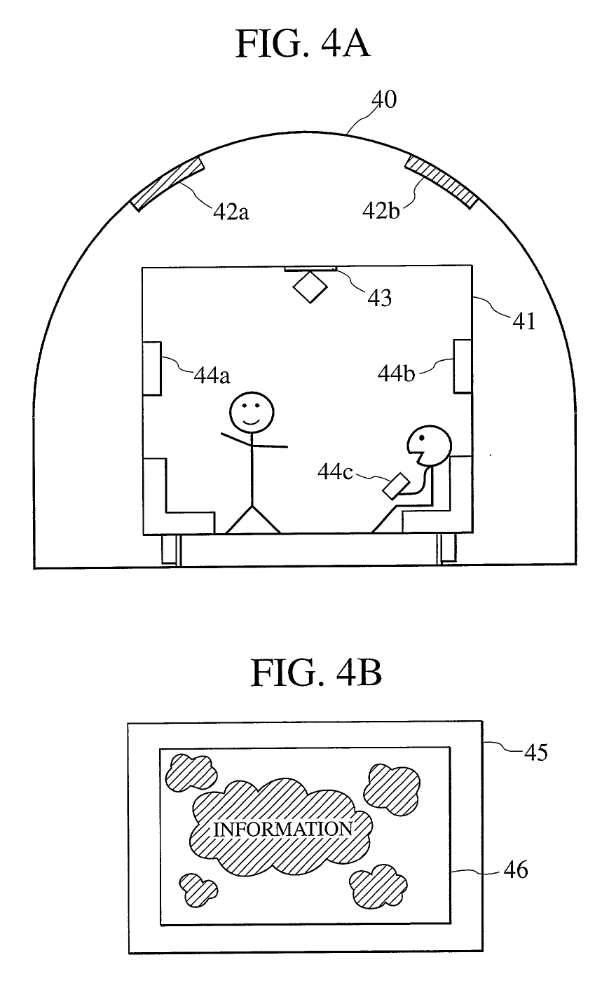

Hereinbelow, an underground broadcasting system for embodying the features in accordance with the present invention will be explained in conjunction with FIG. 1, through FIG. 4. Meanwhile, FIG. 1, FIG. 2, FIG. 3 and FIG. 4 are a schematic diagram showing an information broadcasting system, a schematic diagram for explaining signal processing by the information broadcasting system, a block diagram showing an information transmitter apparatus and a receiver apparatus and a schematic diagram showing the receiver apparatus respectively in accordance with the embodiment of the present invention. This embodiment is described in the case where the underground structure is a network of underground railways as an example for explaining the information broadcasting technique in the underground structure. However, the present invention is applicable also to another underground structure such as an underground shopping area, tunnel.

The underground broadcasting system in accordance with the embodiment of the present invention is composed of an information delivering system 14, transmitter apparatuses 13a and 13b, a transmitter antenna (not shown in the figure), a receiver antenna, a receiver apparatus. The information delivering system 14 serves to store television programs of moving pictures, data broadcast programs and so forth and deliver the programs to the transmitter apparatuses 13a and 13b. The transmitter apparatuses 13a and 13b serve to modulate the data of a program as delivered by the information delivering system 14 on the basis of OFDM (Orthogonal Frequency Division Multiplexing) at the same base band frequency. The transmitter antenna serves to transmit the data of the program on the carriers as modulated by the OFDM modulation. The receiver antenna serves to receive the data of the program on the carriers as modulated by the OFDM modulation as explained in the following description. The receiver apparatus serves to demodulate the data of the program on the carriers as modulated by the OFDM modulation and received by the receiver antenna in order to display the program in an underground structure as explained in the following description. The information delivering system 14 and the transmitter apparatuses 13a and 13b are linked with each other via optical fiber communications.

Meanwhile, the OFDM modulation is a modulation technique on the basis of orthogonal frequency division multiplexing as a kind of the multi-carrier digital modulation schema making use of a number of sub-carriers.

Also, the transmitter apparatuses 13a and 13b are linked with each other not only by an optical fiber network but also by any other electro-communication network implemented with the Internet on the basis of TCP(Transmission Control Protocol)/IP(Internet Protocol), a WAN(Wide Area Network), a satellite communication and so forth.

Furthermore, the information delivering system 14 of the underground broadcasting system 10 is preferably provided with a buffer for the purpose of avoiding a delay time in the same transmission signal occurring between different transmitter apparatuses due to delay spread through the multipaths as illustrated in FIG. 2(a). It is possible to realize the transmission signal process without delay between the transmitter apparatuses 13a and 13b by the process of buffering as illustrated in FIG. 2(b). The process of buffering can be implemented in the transmitter apparatuses in place of the information delivering system 14.

Each of the transmitter apparatuses 13a and 13b is composed of at least a serial-to-parallel converter 31 for converting the data of a program to a parallel data sequence mapped on a complex plane, an inverse discrete Fourier transform unit 32 for performing inverse discrete Fourier transformation of the parallel data sequence in order to generate waveforms of the transmission signals, a frequency converter 33 for performing frequency conversion of the waveforms of the transmission signals in order to generate the OFDM signal containing the data of the program as illustrated in the upper half of FIG. 3.

Meanwhile, in the case of underground railways, the transmitter apparatus is provided on the ceiling of a station yard. However, since the OFDM signals can effectively propagate in an underground structure, the entirety of the network of underground railways can be covered only by providing the transmitter apparatus on the ceilings of selected station yards rather than the ceilings of all the station yards, resulting in reducing the cost of equipment for implementing the information broadcasting system in accordance with the present invention.

On the other hand, as illustrated in the lower half of FIG. 3, the receiver apparatus 34 is composed of a frequency converter 35 for receiving the OFDM signals from the transmitter apparatus 30 and generating waveforms of the received signals, a discrete Fourier transform unit 36 for performing discrete Fourier transformation of the waveforms of the received signals, a parallel-to-serial converter 37 for reproducing the broadcasting data as received on the basis of the phases and the amplitudes of the frequency components of the respective carriers and a display 38 for displaying the broadcasting data to the audience.

More specifically speaking, the receiver apparatus 34 is provided in the respective subway trains in order to receive and demodulate the OFDM signals as transmitted from the transmitter apparatuses 42a and 42b provided on the ceiling of the underground station yard through the antenna 43 as illustrated in FIG. 4(a) and output the broadcasted information to the audience in the form as illustrated in FIG. 4(b).

While the receiver apparatus 34 is provided in the respective subway trains in the case of the present embodiment, a mobile terminal such as a mobile phone, a mobile television or a computer system and so forth is used as the receiver apparatus for viewing the broadcasted information as long as it is capable of demodulating the OFDM signals. It is therefore possible for the audience to enjoy broadcasting services with a better quality everywhere in the underground structure.

In accordance with the underground broadcasting system in accordance with the present invention, since the broadcast information as delivered is modulated on the basis of OFDM at the same base band frequency, the interference between signals is avoided even if the same frequencies are shared by a plurality of stations as long as the timely delay is limited within the guard interval which is a timely gap inserted into the OFDM signals for the purpose of reducing the influence of ghosts due to the multipaths. Also, the interference between signals is avoided even in an ever-changing environment of radio waves reflection in an underground structure such as in an underground station yard through which a plurality of subway trains are traveling so that it is possible to implement an information broadcasting system for receiving broadcast information with a better quality in an underground structure.

It should be understood that the present invention is inclusive of various other embodiments and modifications which are not described here. Accordingly, the present invention should be limited only by matters defining an invention in the claims which are appropriate from the view point of the description.

As explained in the above, in accordance with the underground broadcasting system of the present invention, since the broadcast information as delivered is modulated on the basis of OFDM at the same base band frequency as the modulation technique, it is possible to implement an underground broadcasting system for receiving the broadcast information without degradation and interference in propagation of radio waves even in an underground structure. What is claimed Is:

1. An underground broadcasting system characterized in that broadcast information is broadcasted in an underground structure by the use of modulation on the basis of OFDM at the same base band frequency.

2. The underground broadcasting system as claimed in claim 1 characterized in that said underground structure is a network of underground railways.

3. An underground broadcasting system comprising:
an information delivering system for delivering broadcast information to a transmitter apparatus;
a plurality of transmitter apparatuses for modulating the broadcast information as delivered from said information delivering system on carriers as modulated in accordance with an OFDM modulation at the same base band frequency and transmitting the broadcast information on said carriers; and
a receiver apparatus for receiving the broadcast information as transmitted on said carriers as modulated by the OFDM modulation, demodulating said broadcast information in order to obtain and output the broadcast information as reproduced.

4. The underground broadcasting system as claimed in claim 3 characterized in that transmitter antenna and a receiver antenna are arranged in the underground structure in order to receive and transmit the broadcast information on said carriers as modulated by the OFDM modulation.

5. The underground broadcasting system as claimed in claim 4 characterized in that said information delivering system and said transmitter apparatus are linked with each other by an optical fiber network.

6. The underground broadcasting system as claimed in claim 5 characterized in that said receiver apparatus is a mobile receiver terminal.

7. The underground broadcasting system as claimed in claim 6 characterized in that said underground structure is a network of underground railways.

8. The underground broadcasting system as claimed in claim 5 characterized in that said underground structure is a network of underground railways.

9. The underground broadcasting system as claimed in claim 4 characterized in that said receiver apparatus is a mobile receiver terminal.

10. The underground broadcasting system as claimed in claim 9 characterized in that said underground structure is a network of underground railways.

11. The underground broadcasting system as claimed in claim 4 characterized in that said underground structure is a network of underground railways.

12. The underground broadcasting system as claimed in claim 3 characterized in that said information delivering system and said transmitter apparatus are linked with each other by an optical fiber network.

13. The underground broadcasting system as claimed in claim 12 characterized in that said receiver apparatus is a mobile receiver terminal.

14. The underground broadcasting system as claimed in claim 13 characterized in that said underground structure is a network of underground railways.

15. The underground broadcasting system as claimed in claim 12 characterized in that said underground structure is a network of underground railways.

16. The underground broadcasting system as claimed in claim 3 characterized in that said receiver apparatus is a mobile receiver terminal.

17. The underground broadcasting system as claimed in claim 16 characterized in that said underground structure is a network of underground railways.

18. The underground broadcasting system as claimed in claim 3 characterized in that said underground structure is a network of underground railways.
